(19) United States
(12) Patent Application Publication
(10) Pub. No.: US 2026/0356356 A1
(43) Pub. Date: Nov. 12, 2026

(54) DRIVING ASSISTANCE DEVICE

(71) Applicant: HONDA MOTOR CO., LTD., Tokyo (JP)

(72) Inventor: Tsubasa Nose, Minato-ku, Tokyo (JP)

(21) Appl. No.: 19/125,793

(22) PCT Filed: Nov. 7, 2023
(86) PCT No.: PCT/JP2023/039989

§ 371 Date: Apr. 30, 2025

(30) Foreign Application Priority Data
Dec. 6, 2022 (JP) 2022-194816

(51) Int. Cl. B60W 30/12; B60W 10/184; B60W 10/20; B62J 45/411

(52) U.S. Cl. CPC B60W 30/12; B60W 10/184; B60W 10/20; B62J 45/411; B60W 2300/36; B60W 2520/10; B60W 2520/18; B60W 2710/18; B60W 2710/20

(57) ABSTRACT

A driving assistance device that can inhibit a rider from feeling a difference from the rider's expectation when the steering assist control for the saddle-type vehicle is canceled and the steering holding performed by the rider becomes excessive, and thereby improves the feel given when the control is switched. The driving assistance device includes: a steering control portion configured to perform steering assist control that operates a steering device included in the vehicle; and a braking control portion configured to perform front wheel braking force application control that operates a braking device included in the vehicle to apply a braking force to a front wheel of the vehicle, when a state in which the steering assist control is being performed by the steering control portion is switched to a state in which the steering assist control is not being performed by the steering control portion.

### TECHNICAL FIELD

The present invention relates to a driving assistance device.

### BACKGROUND ART

Conventional driving assistance devices for saddle-type vehicles perform control that operates the steering device of the saddle-type vehicle so that the vehicle travels within a driving lane recognized from an image captured by a camera (see Patent Literature 1, for example). In Patent Literature 1, when the saddle-type vehicle travels along a curve (a curved road), the steering device is controlled to operate at points in time before the vehicle enters the curve, while the vehicle travels in the curve, and after the vehicle exits the curve so that the saddle-type vehicle travels within a lane along a travel path that goes from an outer part, to a center part, and then to the outer part of the lane.

### CITATION LIST

### Patent Literature

### [Patent Literature 1]

International Publication WO 2020/20266

### SUMMARY OF INVENTION

### Technical Problem

When the driving assistance device for a saddle-type vehicle is switched from a state in which the assist control that operates the steering device is performed to a state in which the assist control is canceled so that the rider steers the vehicle, the rider may feel a difference from the rider's expectation.

The present invention has been achieved in view of the background described above, and has an object of providing a driving assistance device that can inhibit a rider from feeling a difference from the rider's expectation when the steering assist control for a saddle-type vehicle is canceled and the steering holding performed by the rider becomes excessive, and thereby improve the feel given when the control is switched.

### Solution to Problem

Japanese Patent Application No. 2022-194816 filed on Dec. 6, 2022 is incorporated herein in its entirety.

In an aspect for achieving the object described above, there is a driving assistance device that assists in steering of a saddle-type vehicle (1), the driving assistance device including: a steering control portion (23) configured to perform steering assist control that operates a steering device (43) included in the saddle-type vehicle; and a braking control portion (24) configured to perform front wheel braking force application control that operates a braking device (41) included in the saddle-type vehicle to apply a braking force to a front wheel of the saddle-type vehicle, when a state in which the steering assist control is being performed by the steering control portion is switched to a state in which the steering assist control is not being performed by the steering control portion.

### Advantageous Effects of Invention

The driving assistance device described above can inhibit a rider from feeling a difference from the rider's expectation when the steering assist control for a saddle-type vehicle is canceled and the steering holding performed by the rider becomes excessive, and thereby improve the feel given when the control is switched.

### BRIEF DESCRIPTION OF DRAWINGS

FIG. 1 is a configuration diagram of a driving assistance device and a saddle-type vehicle including the driving assistance device.

FIG. 2 is a diagram for describing a change in behavior of a vehicle body caused by steering assist control.

FIG. 3 is a flowchart for driving assistance processing performed by a lane departure inhibiting function.

### DESCRIPTION OF EMBODIMENTS

### 1. Configuration of Driving Assistance Device

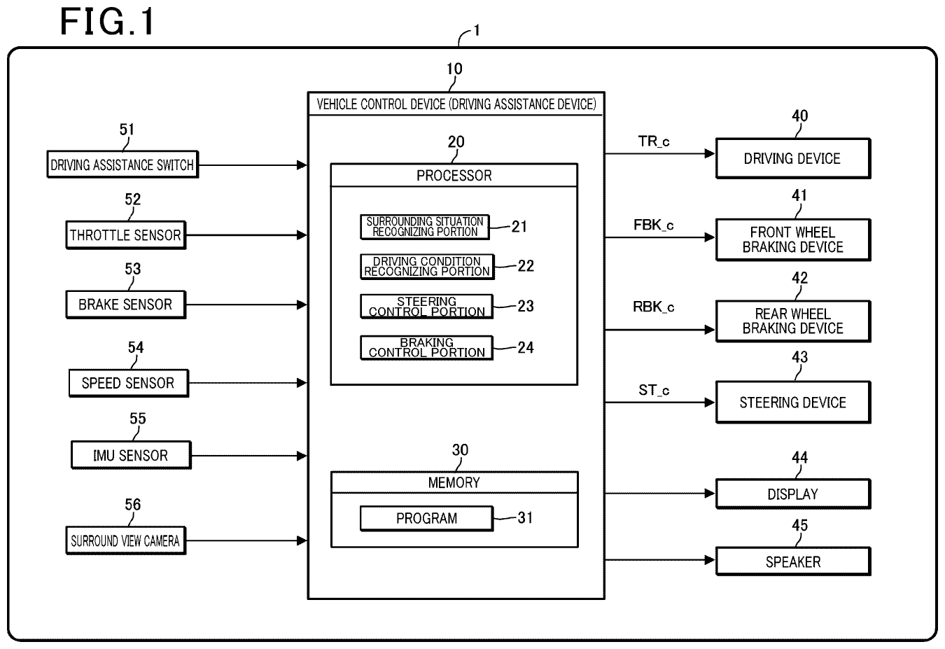

With reference to FIG. 1, a configuration of a driving assistance device according to the present disclosure is described. The driving assistance device according to the present disclosure is configured as part of the function of a vehicle control device 10 that is included in a vehicle 1 and controls the overall operation of the vehicle 1. The vehicle 1 is a saddle-type vehicle that a rider rides by straddling a vehicle body. The vehicle 1 encompasses, besides motorcycles, three-wheeled vehicles (having one front wheel and two rear wheels, or having two front wheels and one rear wheel) categorized as ATVs (all-terrain vehicles) and four-wheeled vehicles.

The vehicle 1 includes: a driving assistance switch 51 that turns ON/OFF a driving assistance function, such as a lane departure inhibiting function to be described below; a throttle sensor 52 that detects a level of manipulation performed for a throttle through an accelerating manipulation portion (such as an accelerator grip); a brake sensor 53 that detects a level of manipulation performed for a brake through a braking manipulation portion (such as a brake lever and a brake pedal) ; a speed sensor 54 that detects a traveling speed of the vehicle 1; an IMU (inertial measurement unit) sensor 55; and a surround view camera 56 that captures an image of the surroundings of the vehicle 1. The IMU sensor 55 detects an angular velocity and an acceleration of the vehicle 1 by using a three-orthogonal-axis gyro sensor and an acceleration sensor.

The vehicle control device 10 receives: a manipulation signal from the driving assistance switch 51; detection signals from the throttle sensor 52, the brake sensor 53, the speed sensor 54, and the IMU sensor 55; and a captured image from the surround view camera 56.

The vehicle 1 further includes a driving device 40, a front wheel braking device 41, a rear wheel braking device 42, a steering device 43, a display 44, and a speaker 45. Operations of the driving device 40, the front wheel braking device 41, the rear wheel braking device 42, and the steering device 43 are controlled through respective control signals TR_c, FBK_c, RBK_c, and ST_c output from the vehicle control device 10. The display 44 displays content in accordance with a control signal output from the vehicle control device 10. The speaker 45 amplifies and outputs a sound signal output from the vehicle control device 10.

The vehicle control device 10 is a control unit that includes a processor 20 and a memory 30. The memory 30 has stored therein a program 31 for the control of the vehicle control device 10. The processor 20 functions as a surrounding situation recognizing portion 21, a driving condition recognizing portion 22, a steering control portion 23, and a braking control portion 24 by reading and executing the program 31.

The surrounding situation recognizing portion 21 recognizes a lane in which the vehicle 1 is traveling (lane of interest), as a surrounding situation of the vehicle 1, based on an image captured by the surround view camera 56. The surrounding situation recognizing portion 21 recognizes the position of the lane of interest (the positions of a left boundary line and a right boundary line) with respect to the vehicle 1. The driving condition recognizing portion 22 recognizes a driving condition of the vehicle 1 based on detection signals from the throttle sensor 52, the brake sensor 53, the speed sensor 54, and the IMU sensor 55.

The steering control portion 23, when in a driving assistance mode, which is started by turning ON the driving assistance switch 51, activates the lane departure inhibiting function that allows the vehicle 1 to avoid departing from the lane of interest recognized by the surrounding situation recognizing portion 21 and performs steering assist control that operates the steering device 43, which is a constituent element that performs the lane departure inhibiting function. The steering assist control of the lane departure inhibiting function can be performed using a publicly known method described in the aforementioned International Publication WO 2020/20266 or the like. When a state in which the steering assist control is being performed is switched to a state in which the steering assist control is not being performed, the braking control portion 24 performs front wheel braking force application control that operates the front wheel braking device 41 to thereby apply a braking force to a front wheel of the vehicle 1.

### [2. Vehicle Behavior Caused by Steering Assist Control]

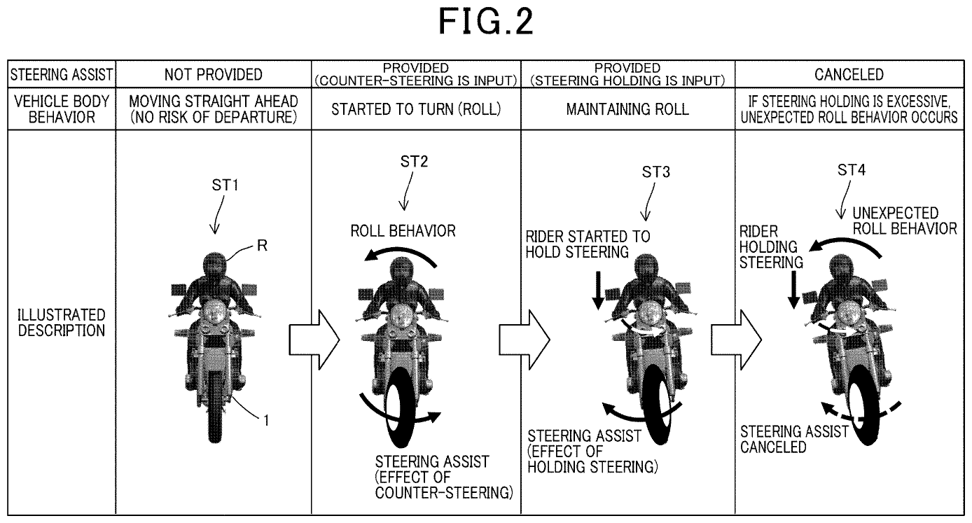

With reference to FIG. 2, a change in behavior of the vehicle body of the vehicle 1 caused by the steering assist control is described below. FIG. 2 shows change in behaviors of the vehicle 1 and a rider R caused when the steering assist control is performed, in the order of ST1, ST2, ST3, and then ST4.

In FIG. 2, ST1 shows a situation in which the vehicle 1 (a two-wheeled vehicle in this case) is traveling straight and there is no risk of the vehicle 1 departing from the lane of interest. At ST1, the steering assist control is not performed. ST2 shows a situation in which the vehicle 1 is approaching a boundary line of the lane of interest, thereby posing a risk of departing from the lane of interest, and the steering assist control has started. At ST2, a roll behavior of the vehicle 1 occurs due to the effect of counter-steering.

ST3 shows a situation in which the steering assist control is continued to maintain the roll of the vehicle 1. In this situation, the handlebar holding force of the rider R and the assist force of the steering device 43 are balanced, thereby maintaining the roll state of the vehicle 1. ST4 shows a situation in which the vehicle 1 has turned and thereby avoided departing from the lane of interest, and the steering assist control has been canceled. Due to the cancellation of the steering assist control, the steering holding that has been achieved by the steering device 43 and has been acting thus far reduces. Thus, if the steering holding achieved by the rider R is excessive, the turning angle of the handlebar increases, possibly causing a roll behavior of the vehicle body that the rider R is not expecting.

Thus, when the steering assist control of the steering control portion 23 is canceled, the braking control portion 24 performs the front wheel braking force application control, which operates the front wheel braking device 41 to apply a braking force to the front wheel of the vehicle 1. Applying a braking force to the front wheel of the vehicle 1 increases a front wheel load, thereby generating a condition that makes it difficult for the rider R to manipulate the handlebar. Thus, excessive steering holding performed by the rider R can be inhibited.

### [3. Driving Assistance Processing by way of Lane Departure Inhibiting Function]

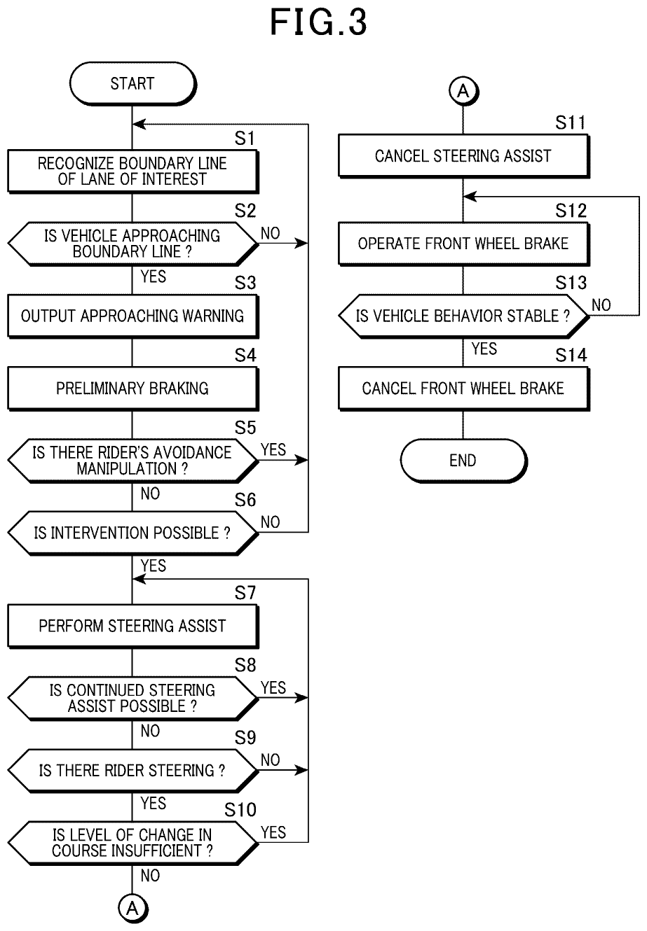

With reference to a flowchart shown in FIG. 3, steps of driving assistance processing by way of the lane departure inhibiting function performed by the vehicle control device 10 are described below.

In FIG. 3, at step S1, the surrounding situation recognizing portion 21 recognizes a boundary line of a lane of interest, in which the vehicle 1 is traveling, from an image captured by the surround view camera 56.

At subsequent step S2, the surrounding situation recognizing portion 21 determines whether the vehicle 1 is approaching the boundary line. If the surrounding situation recognizing portion 21 determines that the vehicle 1 is approaching the boundary line, the processing proceeds to step S3. If the surrounding situation recognizing portion 21 determines that the vehicle 1 is not approaching the boundary line, the processing proceeds to step S1.

At step S3, the surrounding situation recognizing portion 21 outputs an approaching warning to notify the rider R that the vehicle 1 is approaching the boundary line of the lane of interest. As the approaching warning, the surrounding situation recognizing portion 21 displays a warning on the display 44 and outputs a warning sound from the speaker 45. At subsequent step S4, the braking control portion 24 performs preliminary braking that decelerates the vehicle 1 by operating the front wheel braking device 41 and the rear wheel braking device 42.

At subsequent step S5, the driving condition recognizing portion 22 determines whether the rider R has performed avoidance manipulation for avoiding a departure from the lane of interest based on a detection signal from the IMU sensor 55. If the driving condition recognizing portion 22 determines that avoidance manipulation has been performed by the rider R, the processing proceeds to step S1. If the driving condition recognizing portion 22 determines that avoidance manipulation has not been performed by the rider R, the processing proceeds to step S6.

At subsequent step S6, the steering control portion 23 determines whether the vehicle 1 is in a state in which an intervention of the steering assist control is possible based on detection signals from the throttle sensor 52, the brake sensor 53, the speed sensor 54, and the IMU sensor 55. If the steering control portion 23 determines that the vehicle 1 is in a state in which an intervention of the steering assist control is possible, the processing proceeds to step S7. If the steering control portion 23 determines that the vehicle 1 is in a state in which an intervention of the steering assist control is not possible, the processing proceeds to step S1.

At step S7, the steering control portion 23 performs the steering assist control to operate the steering device 43 in a direction in which the vehicle 1 moves away from the boundary line of the lane of interest. In subsequent step S8, the steering control portion 23 determines whether the vehicle 1 is in a state in which the intervention of the steering assist control can be continued based on detection signals from the throttle sensor 52, the brake sensor 53, the speed sensor 54, and the IMU sensor 55. If the steering control portion 23 determines that the vehicle 1 is in a state in which the intervention of the steering assist control can be continued, the processing proceeds to step S7. If the steering control portion 23 determines that the vehicle 1 is in a state in which the intervention of the steering assist control cannot be continued, the processing proceeds to step S9.

At step S10, the steering control portion 23 determines whether the level of change in course of the vehicle 1 is insufficient to avoid a departure from the lane of interest. If the steering control portion 23 determines that the level of change in course of the vehicle 1 is insufficient, the processing proceeds to step S7. If the steering control portion 23 determines that the level of change in course of the vehicle 1 is sufficient, the processing proceeds to step S11.

At step S11, the steering control portion 23 ends the steering assist control (cancellation of the steering assist control). At subsequent step S12, the braking control portion 24 performs the front wheel braking force application control, which operates the front wheel braking device 41 to apply a braking force to the front wheel of the vehicle 1 (a front wheel brake is operated). Here, it is assumed that when the vehicle 1 is traveling at a high speed, a certain degree of steering heaviness is maintained due to the gyro effect of the front wheel and the like.

The braking control portion 24 may operate the front wheel braking device 41 in a manner depending on the speed of the vehicle 1 at a point in time when the steering assist control is canceled so that a greater braking force is applied to the front wheel at a lower speed of the vehicle 1. An excessively low speed of the vehicle 1 poses a risk of the vehicle body becoming unstable, and thus the braking force applied to the front wheel by the front wheel braking device 41 may be regulated in accordance with the vehicle speed, roll angle, and roll angular velocity of the vehicle 1.

At subsequent step S13, the braking control portion 24 recognizes the roll angle and roll angular velocity of the vehicle 1 based on a detection signal from the IMU sensor 55 and determines whether the behavior of the vehicle 1 is stable. The braking control portion 24 determines a stable state of the vehicle 1 by determining, for example, whether a roll behavior condition is satisfied. The roll behavior condition is satisfied if the roll angle and roll angular velocity of the vehicle 1 fall within a predefined range in a predetermined two-dimensional map of the roll angle and roll angular velocity.

If the braking control portion 24 determines that the behavior of the vehicle 1 is stable, the processing proceeds to step S14. If the braking control portion 24 determines that the behavior of the vehicle 1 is not stable, the processing proceeds to step S12. At step S14, the braking control portion 24 causes the front wheel braking device 41 to end the application of a braking force to the front wheel of the vehicle 1 (front wheel braking is canceled).

When the rider R is performing correct steering, the front wheel braking force application control may not be performed. Correct steering may be determined by determining whether immediate cancellation of the steering assist control is likely to cause no problematic situation based on a steering torque or the like.

Alternatively, if a steering torque sensor is unwanted, the rider R's steering condition may be estimated and determined based on a roll angular velocity or the like of the vehicle 1 recognized from a detection signal from the IMU sensor 55.

### [4. Other Embodiments]

While the foregoing embodiment describes a case in which the steering assist control is performed by the lane departure inhibiting function, the invention of the present disclosure can be also applied to a case in which the steering assist control is performed by another driving assistance function, such as obstacle avoidance.

Note that FIG. 1 is a schematic diagram that shows a functional configuration of the driving assistance device in such a manner that divides the configuration according to main processing in order to facilitate understanding of the invention of the present disclosure. The functional configuration of the driving assistance device may be divided differently. Processing of each constituent element may be performed by one hardware unit or a plurality of hardware units. Processing of each constituent element of the driving assistance device shown in FIG. 3 may be performed by one program or a plurality of programs.

### [5. Configurations Supported by the Embodiments Described Above]

The foregoing embodiments describe specific examples of the following configurations.

(First configuration) A driving assistance device that assists in steering of a saddle-type vehicle (1), the driving assistance device including: a steering control portion (23) configured to perform steering assist control that operates a steering device (43) included in the saddle-type vehicle; and a braking control portion (24) configured to perform front wheel braking force application control that operates a braking device (41) included in the saddle-type vehicle to apply a braking force to a front wheel of the saddle-type vehicle, when a state in which the steering assist control is being performed by the steering control portion is switched to a state in which the steering assist control is not being performed by the steering control portion.

In accordance with the driving assistance device of the first configuration, a rider can be inhibited from feeling a difference from the rider's expectation when the steering assist control for the saddle-type vehicle is canceled and the steering holding performed by the rider becomes excessive, and the feel given when the control is switched can be improved.

(Second configuration) The driving assistance device according to the first configuration, further including a driving condition recognizing portion (22) that recognizes a driving condition of the saddle-type vehicle, wherein, when the braking control portion determines that the saddle-type vehicle has reached a predefined stable state based on the driving condition after the braking control portion has started the front wheel braking force application control, the braking control portion ends the front wheel braking force application control.

In accordance with the driving assistance device of the second configuration, the braking force application control can be ended at an appropriate timing when the saddle-type vehicle achieves the stable state.

(Third configuration) The driving assistance device according to the second configuration, wherein the driving condition recognizing portion recognizes a roll angle and a roll angular velocity of the saddle-type vehicle as the driving condition of the saddle-type vehicle, and the braking control portion determines that the roll angle and the roll angular velocity of the saddle-type vehicle satisfy a predefined roll behavior condition as the stable state.

In accordance with the driving assistance device of the third configuration, the stable state of the saddle-type vehicle can be determined based on the roll angle and roll angular velocity of the saddle-type vehicle.

(Fourth configuration) The driving assistance device according to the first configuration, further including a driving condition recognizing portion that recognizes a speed of the saddle-type vehicle as a driving condition of the saddle-type vehicle, wherein the braking control portion changes a braking force applied to the front wheel of the saddle-type vehicle by the front wheel braking force application control based on the speed of the saddle-type vehicle at a point in time when the state in which the steering assist control is being performed by the steering control portion is switched to the state in which the steering assist control is not being performed by the steering control portion.

In accordance with the driving assistance device of the fourth configuration, the braking force to be applied to the front wheel by the front wheel braking force application control can be set appropriately in correspondence with the steering heaviness of the saddle-type vehicle, which changes with the traveling speed of the saddle-type vehicle.

(Fifth configuration) The driving assistance device according to any one of the first to fourth configurations, further including a surrounding situation recognizing portion (21) that recognizes a surrounding situation of the saddle-type vehicle, wherein the steering control portion performs the steering assist control as a constituent element that is included in the saddle-type vehicle and that performs a lane departure inhibiting function that operates the steering device so that the saddle-type vehicle does not depart from a lane of interest recognized from the surrounding situation, the lane of interest being a lane in which the saddle-type vehicle is traveling.

In accordance with the driving assistance device of the fifth configuration, when the steering assist control performed by the lane departure inhibiting function is canceled, the feel given when the control is switched can be improved.

### INDUSTRIAL APPLICABILITY

The driving assistance device according to the present disclosure can be used for purposes of inhibiting a rider from feeling a difference from the rider's expectation when the steering assist control for a saddle-type vehicle is canceled and the steering holding performed by the rider becomes excessive, and of improving the feel given when the control is switched.

### REFERENCE SIGNS LIST

vehicle, 10 vehicle control device (driving assistance device), 20 processor, 21 surrounding situation recognizing portion, 22 driving condition recognizing portion, 23 steering control portion, 24 braking control portion, 30 memory, 31 program, 40 driving device, 41 front wheel braking device, 42 rear wheel braking device, 43 steering device, 51 driving assistance switch, 52 throttle sensor, 53 brake sensor, 54 speed sensor, 55 IMU sensor, 56 surround view camera

1. A driving assistance device that assists in steering of a saddle-type vehicle, the driving assistance device comprising:
a steering control portion configured to perform steering assist control that operates a steering device included in the saddle-type vehicle; and
a braking control portion configured to perform front wheel braking force application control that operates a braking device included in the saddle-type vehicle to apply a braking force to a front wheel of the saddle-type vehicle, when a state in which the steering assist control is being performed by the steering control portion is switched to a state in which the steering assist control is not being performed by the steering control portion.

2. The driving assistance device according to claim 1, further comprising a driving condition recognizing portion that recognizes a driving condition of the saddle-type vehicle,
wherein, when the braking control portion determines that the saddle-type vehicle has reached a predefined stable state based on the driving condition after the braking control portion has started the front wheel braking force application control, the braking control portion ends the front wheel braking force application control.

3. The driving assistance device according to claim 2, wherein the driving condition recognizing portion recognizes a roll angle and a roll angular velocity of the saddle-type vehicle as the driving condition of the saddle-type vehicle, and
the braking control portion determines that the roll angle and the roll angular velocity of the saddle-type vehicle satisfy a predefined roll behavior condition as the stable state.

4. The driving assistance device according to claim 1, further comprising a driving condition recognizing portion that recognizes a speed of the saddle-type vehicle as a driving condition of the saddle-type vehicle,
wherein the braking control portion changes a braking force applied to the front wheel of the saddle-type vehicle by the front wheel braking force application control based on the speed of the saddle-type vehicle at a point in time when the state in which the steering assist control is being performed by the steering control portion is switched to the state in which the steering assist control is not being performed by the steering control portion.

5. The driving assistance device according to claim 1, further comprising a surrounding situation recognizing portion that recognizes a surrounding situation of the saddle-type vehicle,
wherein the steering control portion performs the steering assist control as a constituent element that is included in the saddle-type vehicle and that performs a lane departure inhibiting function that operates the steering device so that the saddle-type vehicle does not depart from a lane of interest recognized from the surrounding situation, the lane of interest being a lane in which the saddle-type vehicle is traveling.

6. The driving assistance device according to claim 1, wherein the braking control portion determines whether or not to perform the front wheel braking force application control based on a steering operation of the saddle-type vehicle, the steering operation being estimated from detection or a detection result by a steering torque sensor or inertial measurement unit (IMU) sensor.
